(19) United States
(12) Patent Application Publication
(10) Pub. No.: US 2021/0086344 A1
(43) Pub. Date: Mar. 25, 2021

(54) SEWING TAPE MEASURES WITH PRINT-ON ANTI-SLIP STRUCTURE

(71) Applicant: Chi-Jen CHEN, Xihu Township (TW)

(72) Inventor: Chi-Jen CHEN, Xihu Township (TW)

(21) Appl. No.: 16/579,308

(22) Filed: Sep. 23, 2019

(51) Int. Cl. B25H 1/00; G01B 3/04

(52) U.S. Cl. CPC B25H 1/00; G01B 3/04

(57) ABSTRACT

A sewing tape measure with a print-on anti-slip structure includes a transparent substrate and a reference line unit disposed on top surface or a bottom surface of the transparent substrate. The reference line unit includes a plurality of lateral main reference lines and longitudinal main reference lines. Each adjacent longitudinal main reference line is provided with a plurality of secondary reference lines, and a no reference line area is defined between adjacent lateral main reference lines, adjacent longitudinal main reference lines and adjacent secondary reference lines. The plural print-on anti-slip parts are disposed on the bottom surface of the transparent substrate at the interval, each print-on anti-slip part is printed by the printing ink with a anti-slip property, and each print-on anti-slip part is distributed within the range of no reference line area.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to a sewing tape measure, and more particularly to a sewing tape measure with a print-on anti-slip structure.

### 2. Description of Related Art Including Information Disclosed Under 37 CFR 1.97 and 37 CFR 1.98

The conventional sewing tape measure has functions such as drawing angles and oblique lines, measuring angles, fixing distances, etc. It is convenient for the user to identify size and distance while making plate and cutting cloth.

Further, since the sewing tape measure is directly pressed against the cloth when cutting the cloth, in order to avoid any eccentric slip between the sewing tape measure and the cloth, the tailor places an anti-slip structure on the bottom surface of the sewing tape measure. The conventional sewing tape measure is provided with a anti-slip structure, such as U.S. Ser. No. 07/509,745, the device for measuring materials disclosed in the prior patent, the working surface of the transparent substrate is provided with a UV-hardened coating to achieve anti-slip effect. The UV-hardened coating is required to pass through the ultraviolet irradiation to achieve a dry and solidified state after coating, so that not only the material and the production cost are high, although the UV-hardened coating has the advantage of wear resistant, solvent resistance, resistance to impact and high strength after being hardened, but because the surface is too smooth, it is not suitable for the actual use of the anti-slip function and it is difficult to meet the requirements of the sewing tape measure operation.

Further, the UV-hardened coating disclosed in the aforementioned U.S. Ser. No. 07/509,745 patent is mainly disposed along a longitudinal reference line and a lateral reference line on the transparent substrate. However, in such a conventional structural arrangement type, because the transmittance of the UV-hardened coating and the transparent substrate may be different, and the distribution area of the UV-hardened coating is generally larger than the line width of the longitudinal reference line and the lateral reference line, therefore, the profile clarity of the longitudinal reference line and the lateral reference line is usually affected to a certain extent, which causes the user to be blurred and difficult to identify when viewing the dimension scale.

Therefore, in view of the problems of the above-mentioned conventional sewing tape measure, how to develop an innovative structure that can be more ideal and practical, and the relevant industry should further consider the goal and direction of breakthrough; in view of this, based on the inventor's experience in the manufacturing and design of related products for many years, after detailed design and careful evaluation, the invention has finally become practical.

### BRIEF SUMMARY OF THE INVENTION

The main object of the present invention is to provide a sewing tape measure with a print-on anti-slip structure. The technical problems to be solved are to consider and innovate how to develop a new sewing tape measure structure with more ideal practicability.

Based on said purpose, the sewing tape measure comprises a transparent substrate, a rectangular plate shape made of transparent material, a transparent substrate comprising a top surface, a bottom surface and four sides, four sides are provided with a plural scale with equal spacing; a reference line unit is disposed on one of a top surface or a bottom surface of the transparent substrate, the reference line unit includes plural lateral main reference lines and plural longitudinal main reference lines, which are orthogonal to each other, and each of the adjacent longitudinal main reference lines is provided with a plurality of reference lines which are equidistant and mutually parallel. and each lateral main reference line and each longitudinal main reference line are provided with an identification point, and no reference line area is respectively defined between the adjacent lateral main reference lines, the adjacent longitudinal main reference lines and adjacent secondary reference lines; The plural print-on anti-slip parts are disposed on the bottom surface of the transparent substrate in a spaced distribution type, and each print-on anti-slip part is printed by printing ink with an anti-slip property, and the protruding thickness of each print-on anti-slip part is between 0.05 mm and 0.50 mm; and each print-on anti-slip part is distributed within no reference line area, and a configuration relationship staggered to each other is formed between the print-on anti-slip part and the lateral main reference line, and between the longitudinal main reference line and the secondary reference line.

The main effects and advantages of the present invention include the following points:

(1) The print-on anti-slip part is characterized by the use of the printing ink with the anti-slip property. Since the print-on anti-slip part is dry-formed immediately after printing, the ultraviolet irradiation process of the prior art can be omitted. Therefore, it has the advantages of simplifying the process and reducing the cost, and the anti-slip effect is further improved, and the sewing tape measure can be used to achieve a comprehensive anti-slip, effectively preventing slippage and thereby improving the safety of use and the practical progress.

(2) The technical feature that the print-on anti-slip part is distributed within the no reference line area forms a staggered configuration relationship between each print-on anti-slip part and the lateral main reference line, the longitudinal main reference line and the secondary reference line. The profile of each reference line is clearly presented and completely unaffected by the print-on anti-slip part, thereby greatly improving the identification clarity, work quality and work efficiency of the use of the sewing tape measure.

Another object of the present invention is further to provide another technical feature of the seam allowance marking block in the rectangular frame color block type disposed at the internal retraction intervals of the four sides of the transparent substrate, thereby helping the user to draw the seam size of the cloth.

Another object of the present invention is further to improve the anti-slip effect by providing another technical feature of a printing-forming anti-slip part within the seam allowance marking block.

For another object of the present invention, the reference line unit includes an angle line unit, which includes two 30° graticules, two 45° graticules and two 60° graticules, and another technical feature is the symmetrical and interlacing configuration relationship between two 30° graticules, two 45° graticules and two 60° graticules, thereby helping the user to identify the inclination angle of plate making or cutting operation.

### BRIEF DESCRIPTION OF THE SEVERAL VIEWS OF THE DRAWINGS

FIG. 1 is an elevation angle three-dimensional diagram of a preferred embodiment of the present invention.

FIG. 2 is a partial enlargement diagram of FIG. 1.

FIG. 3 is an upward view of a preferred embodiment of the present invention.

FIG. 4 is a top view of a preferred embodiment of the present invention.

FIG. 5 is a sectional view of the partial structure of a preferred embodiment of the present invention.

FIG. 6 is an embodiment diagram of the non-uniformly spaced distribution of the print-on anti-slip part of the present invention.

FIG. 7 is an embodiment diagram 1 of the sewing tape measure use of the present invention.

FIG. 8 is an embodiment diagram 2 of the sewing tape measure use of the present invention.

FIG. 9 is an embodiment diagram of the seam allowance marking block additionally disposed at the transparent substrate of the present invention.

FIG. 10 is an embodiment diagram of the print-on anti-slip part disposed at the seam allowance marking block, continuing FIG. 9.

### DETAILED DESCRIPTION OF THE INVENTION

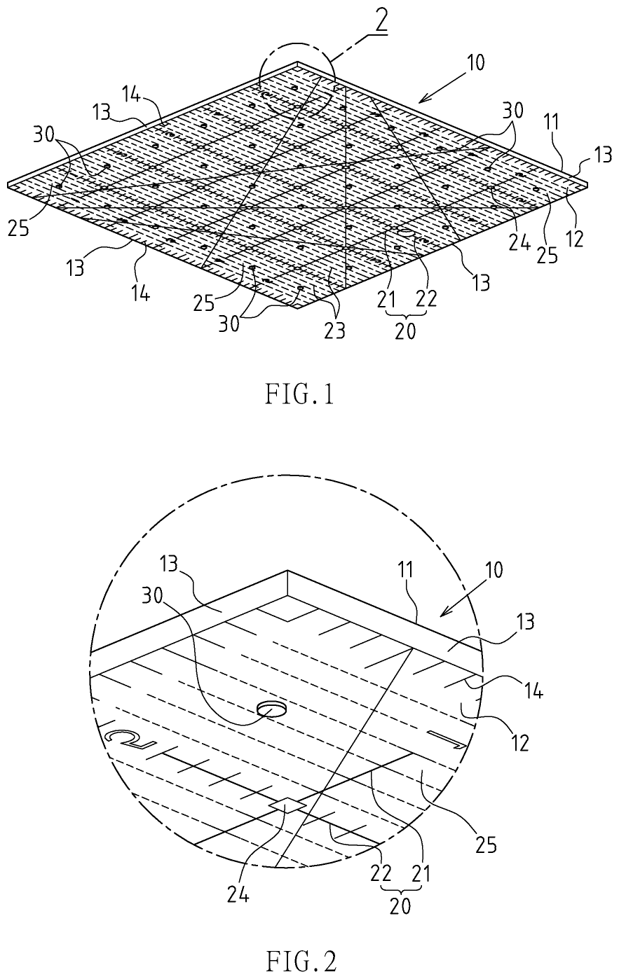

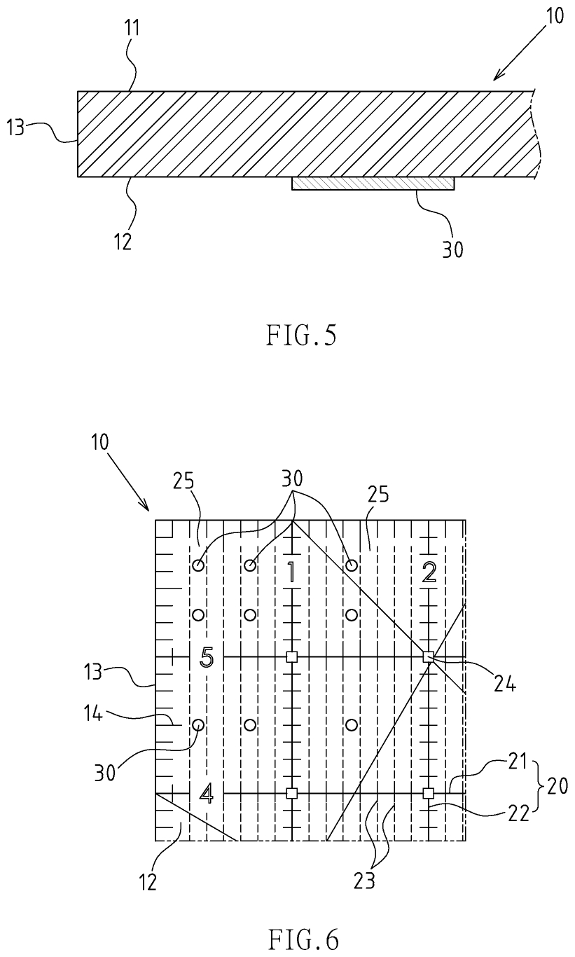

Referring to FIGS. 1 to 5 for the preferred embodiments of the sewing tape measures with print-on anti-slip structure of the present invention, the embodiments are for illustrative purposes only, and the patent application is not restricted by this structure.

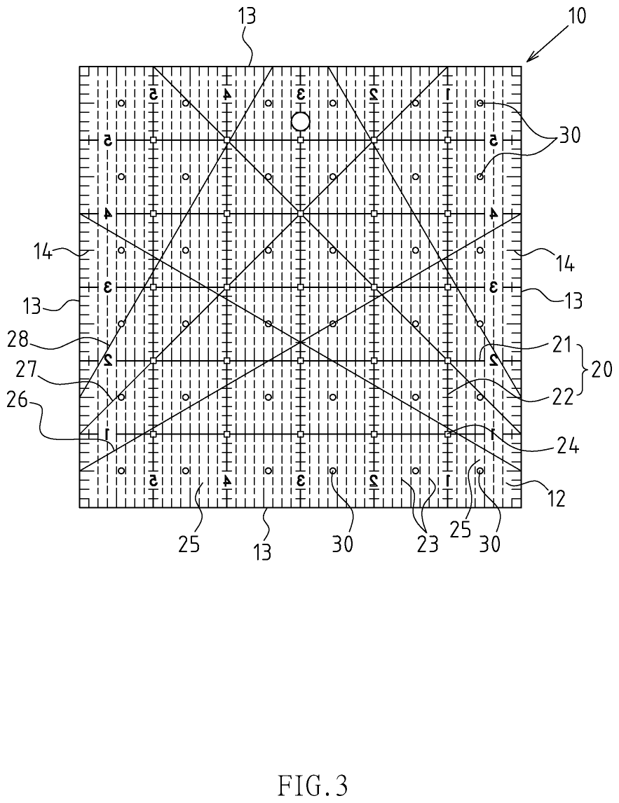

The sewing tape measure comprises a transparent substrate 10 with a rectangular plate body shape made of a transparent material (such as transparent acryl), the transparent substrate 10 including a top surface 11, a bottom surface 12 and four sides 13, wherein the four sides 13 are provided with a plurality of scales 14 of equal spacing; a reference line unit 20, which is disposed on one of the top surface 11 or the bottom surface 12 of the transparent substrate 10 (note: this example is set on the bottom surface 12), and the reference line unit 20 includes a plurality of lateral main reference line 21 and a plurality of longitudinal main reference line 22 in the orthogonally intersecting relationship state, each adjacent longitudinal main reference line 22 is provided with a plurality of secondary reference lines 23 which are equidistant and mutually parallel, each lateral main reference line 21 and the longitudinal main reference line 22 are provided with an identification point 24 at the interlaced position, and a no reference line area 25 is defined respectively between the adjacent lateral main reference lines 21, the adjacent longitudinal main reference lines 22 and the adjacent secondary reference lines 23; a plurality of print-on anti-slip part 30 are disposed on the bottom surface 12 of the transparent substrate 10 in a spaced distribution, and each print-on anti-slip part 30 is printed by the printing ink with an anti-slip property, and the protruding thickness of the print-on anti-slip portion 30 is between 0.05 mm and 0.50 mm; and wherein each print-on anti-slip part 30 is distributed within the no reference line area 25, and the staggered configuration relationship is formed between the print-on anti-slip part 30 and the lateral main reference line 21, the longitudinal main reference line 22 and the secondary reference line 23.

Wherein, the print-on anti-slip part 30 is composed of the Thermoplastic Polyurethane (TPU). The TPU used in this example is an elastomer material between rubber and plastic. It has many advantages, first of all, in terms of rigidity, TPU has a wide range of hardness, from Shore A 60 Shore D 80, and has high elasticity throughout the hardness range; TPU is flexible over a wide temperature range (40˜120?) and does not require the incorporation of plasticizers; TPU has good resistance to the oils (such as mineral oils, animal and vegetable oils as well as lubricants) and many solvents; TPU has good resistance to the weather, excellent resistance to high-energy ray and well-known resistance to the wear and the tear, and flexural strength is excellent, and it has significant advantages, such as high tensile strength, high elongation rate, low long-term compression permanent deformation rate.

Wherein, the plurality of print-on anti-slip parts 30 are distributed at equal intervals or at different intervals; this part of the print-on anti-slip part 30 as shown in FIG. 3 is equally spaced; as shown in FIG. 6, the print-on anti-slip part 30 is in a non-equally spaced configuration state. The contour shape of each print-on anti-slip part 30 is not limited, such as: roundness, ellipse, rectangle, diamond and polygon, or irregular contour shapes, which can be realized in the current process technology of the relevant industry.

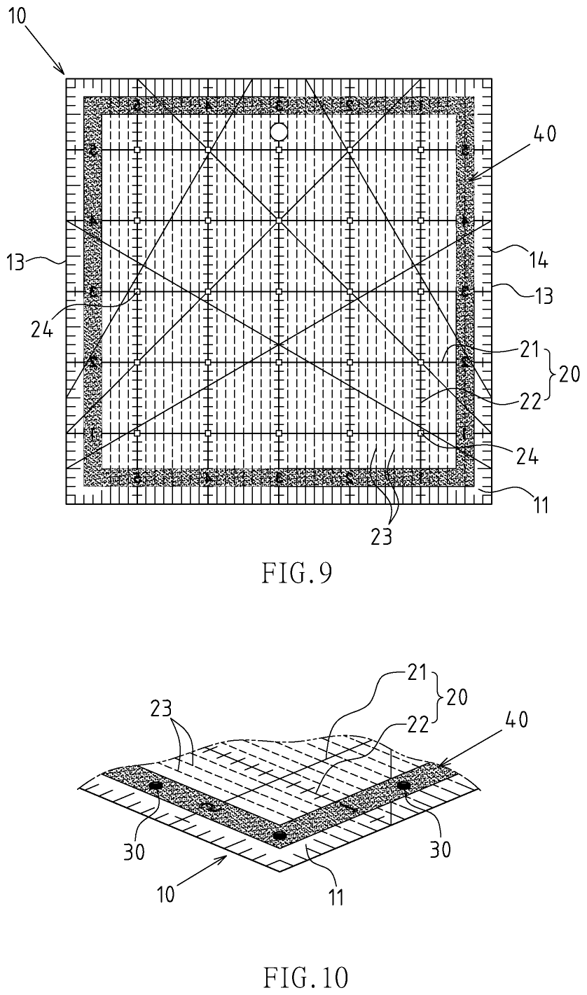

As shown in FIG. 9, in this example, the transparent substrate 10 is provided with a bottom surface 12 (or top surface 11) of the reference line unit 20, and a seam allowance marking block 40 in the rectangular frame color block type is arranged at the internal contraction interval of the four sides 13. As shown in FIG. 10, the print-on anti-slip part 30 is also disposed within the seam allowance marking block 40.

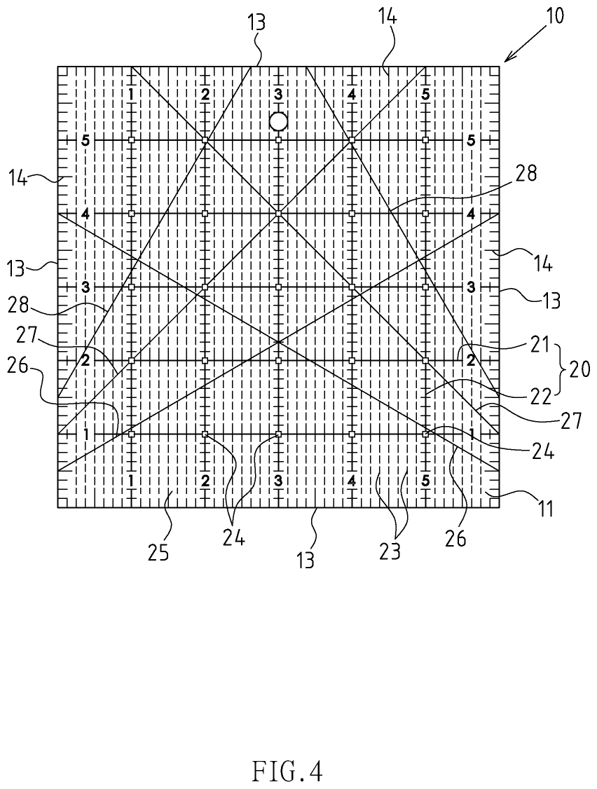

As shown in FIG. 4, in this example, the reference line unit 20 further includes an angle line unit (no label), the angle line unit includes two 30° graticules 26, two 45° graticules 27 and two lines 60° graticules 28, and wherein the two 30° graticules 26, the two 45° graticules 27 and the two 60° graticules 28 are arranged symmetrically and mutually staggered; The angle line unit disclosed in this example is mainly used to help the user to identify the inclination angle of the plate making or cutting operation. (Note: because the print-on anti-slip part 30 is usually made of transparent material, in FIG. 4, that is, the print-on anti-slip part 30 is not drawn, and the disorder problem of the state recognition of the bottom surface 12 and the top surface 11 of the transparent substrate 10 is avoided.

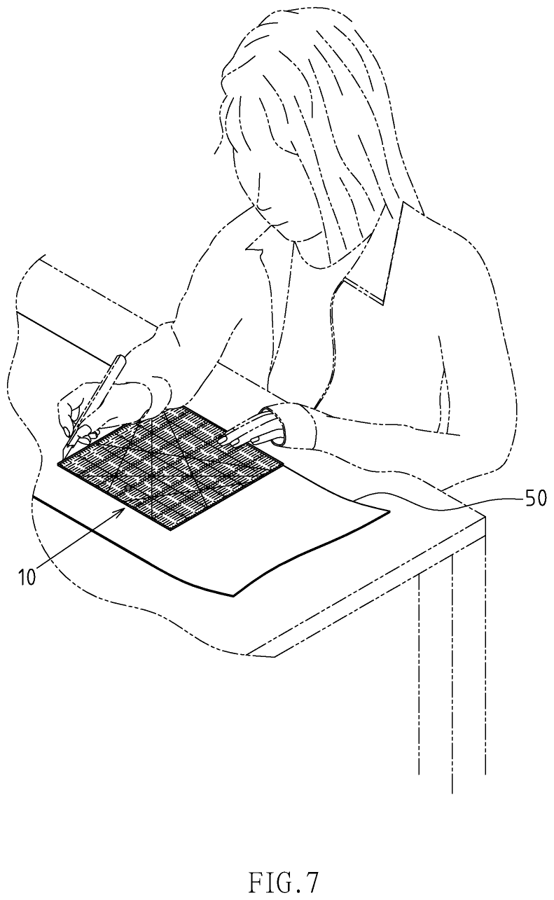

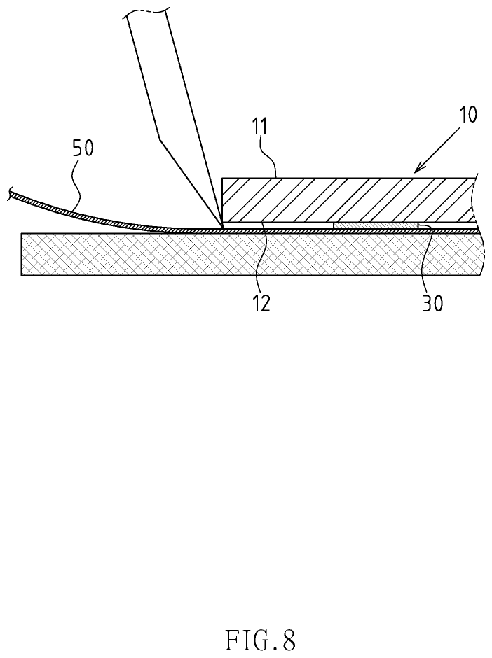

According to the structural composition and technical features described above, the sewing tape measure disclosed in the present invention is used as shown in FIG. 7, and the user places the sewing tape measure on the cloth 50 for making plate or cutting. The transparent substrate 10 is provided with a scale 14, a lateral main reference line 21, a longitudinal main reference line 22, a secondary reference line 23, and an identification point 24 (refer to FIG. 4) to provide a reference for the user making plate or cutting; in addition, when the sewing tape measure is placed on the cloth 50 (as shown in FIG. 8), the bottom surface 12 of the transparent substrate 10 of the sewing tape measure is abutted on the cloth 50 through the print-on anti-slip part 30, because the print-on anti-slip part 30 is printed by printing ink with anti-slip property, so it can greatly improve the anti-slip effect of the sewing tape measure, achieve a comprehensive anti-slip, effectively prevent slippage and improve the safety of use; On the other hand, since the print-on anti-slip part 30 is distributed within the range of the no reference line area 25, the staggered configuration relationship is formed between the print-on anti-slip part 30 and the lateral main reference line 21, the longitudinal main reference line 22 and the secondary reference line 23, so the profile of each reference line is clearly presented and completely unaffected by the print-on anti-slip part 30, thereby greatly improving the identification clarity, work quality and work efficiency of the sewing tape measure.

I claim:

1. A sewing tape measures with print-on anti-slip structure, the sewing tape measure comprising:
a transparent substrate is a rectangular plate body shape made of a transparent material, the transparent substrate includes a top surface, a bottom surface and four sides, wherein the four sides are provided with a plurality of scales of equal spacing;
a reference line unit is disposed on one of a top surface or a bottom surface of the transparent substrate, the reference line unit includes a plurality of lateral main reference lines and a plurality of longitudinal main reference lines, which are orthogonally staggered to each other. A plurality of secondary reference lines are arranged equidistantly and in parallel with each other between the adjacent longitudinal main reference lines, the lateral main reference line and the longitudinal main reference line are provided respectively with an identification point at the interlaced position, and a no reference line area is defined between the adjacent lateral main reference lines, the adjacent longitudinal main reference lines and the adjacent secondary reference lines; and
a plurality of print-on anti-slip parts are disposed on the bottom surface of the transparent substrate, and each print-on anti-slip part is printed by the printing ink with an anti-slip property, and the protruding thickness of each print-on anti-slip part is between 0.05 mm and 0.50 mm;
wherein, each print-on anti-slip part is distributed within the range of the no reference line area, and the staggered configuration relationship is formed between the print-on anti-slip part and the lateral main reference line, the longitudinal main reference line and the secondary reference line.

2. The sewing tape measures with print-on anti-slip structure defined in claim 1, wherein the print-on anti-slip part is composed of thermoplastic polyurethane.

3. The sewing tape measures with print-on anti-slip structure defined in claim 2, wherein the plural print-on anti-slip parts are distributed at equal intervals or at different intervals.

4. The sewing tape measures with print-on anti-slip structure defined in claim 3, wherein the transparent substrate is provided with a top surface or a bottom surface of the reference line unit, and a seam allowance marking block in the rectangular frame color block type is disposed at the internal contraction interval.

5. The sewing tape measures with print-on anti-slip structure defined in claim 4, wherein the print-on anti-slip part is also disposed within the seam compensation marking block.

6. The sewing tape measures with print-on anti-slip structure defined in claim 5, wherein the reference line unit includes an angle line unit, which includes two 30° graticules, two 45° graticules and two lines 60° graticules, and wherein the two 30° graticules, the two 45° graticules and the two 60° graticules are arranged symmetrically and mutually staggered.
